(19) United States
(12) Patent Application Publication
(10) Pub. No.: US 2005/0213596 A1
(43) Pub. Date: Sep. 29, 2005

(54) Communication circuit and method

(75) Inventor: Noriyuki Mizutani, Kanagawa (JP)

Correspondence Address: MCGINN & GIBB, PLLC, 8321 OLD COURTHOUSE ROAD, SUITE 200, VIENNA, VA, 22182-3817, US

(73) Assignee: NEC Electronics Corporation, Kawasaki (JP)

(21) Appl. No.: 11/086,765

(22) Filed: Mar. 23, 2005

(30) Foreign Application Priority Data
Mar. 25, 2004 (JP) 2004-088700

(51) Int. Cl. H04L 12/28; H04L 12/26; H04J 3/14; H04J 1/16; H04L 1/00

(52) U.S. Cl. 370/431; 370/241

(57) ABSTRACT

Disclosed is a communication circuit, for monitoring and maintaining an interface transmission path, which is connected to an opposite communication circuit via a plurality of serial data transmission paths and includes a link establishment detector, an idle generator and a link monitoring unit. The link establishment detector detects link status, which indicates whether reception is possible from receive data that enters from the plurality of serial data transmission paths, and outputs link establishment information. The idle generator generates transmit data, which indicates the link status, based upon the link establishment information and transmits the transmit data to the plurality of serial data transmission paths. The link monitoring unit extracts the link establishment information, which is sent by the opposite communication circuit, from the receive data that enters from the plurality of serial data transmission paths. The communication circuit sends and receives the link establishment information to and from the opposite communication circuit, whereby the communication circuits monitor each other's link status.

### FIELD OF THE INVENTION

This invention relates to a communication circuit and method. More particularly, the invention relates to a communication circuit and method having a function for monitoring establishment of a link.

### BACKGROUND OF THE INVENTION

A 10 Gigabit Ethernet (registered trademark) XAUI [10 Gigabit (X) Attachment Unit Interface] is technology used in short-distance connection between LSIs. Methods of use in which an XAUI interface is applied to a back-plane connection or cable connection in an apparatus are coming into ever-wider use.

A conventional serial communication scheme exemplified by a 10 Gigabit Ethernet (registered trademark) XAUI interface will be described with reference to FIG. 1. FIG. 1 illustrates the configuration of a system in which communication circuits 101A and 101B communicate with each other by an XAUI interface. The communication circuit 101A is connected by a control circuit A (not shown) and an XGMII (10 Gigabit Media Independent Interface). The communication circuit 101B is connected by another control circuit B (not shown) and an XGMII. The communication circuits 101A and 101B intervene in the information sent and received between the control circuits A and B. Data in units referred to as columns constantly flow between the communication circuits 101A and 101B. Columns include data columns that handle the data of MAC frames and idle columns that flow into an IFG (Inter-Frame Gap) between MAC frames.

The communication circuit 101A has a transmitter 110A and a receiver 120A. The transmitter 10A has an 8B/10B encoder 112A, an idle generator 114A and a serializer 116A. The receiver 120A has a deserializer 121A, a sync detector 123A, an align detector 125A and an 8B/10B decoder 127A. The communication circuit 101B of the opposite station similarly has a transmitter 110B and a receiver 120B. The transmitter 110B has an 8B/10B encoder 112B, an idle generator 114B and a serializer 116B. The receiver 120B has a deserializer 121B, a sync detector 123B, an align detector 125B and an 8B/10B decoder 127B.

Data transmitted to the control circuit B enters the transmitter 110A of the communication circuit 101A from the control circuit A. Parallel data that enters the transmitter 110A is input to the 8B/10B encoder 112A, and 8-bit parallel data is converted to 10-bit code. The data that has been converted to the 10-bit code is input to the idle generator 114A. When data enters from the 8B/10B encoder 112A, the idle generator 114A outputs this data. When data does not enter from the 8B/10B encoder 112A, i.e., in the IFG, the idle generator 114A generates and outputs an idle column. A data column and idle column that are output from the idle generator 114A are input to the serializer 116A. The latter converts 10-bit parallel data to serial data and outputs the serial data.

Only one lane is shown in FIG. 1 in order to simplify the description. This serial transmission path, however, has four lanes. The parallel data in each lane is similarly converted to serial data and transmitted to the communication circuit 101B.

The output serial data is input to the receiver 120B of the opposite communication circuit 101B. The serial data that enters is converted to parallel data by the deserializer 121B and the parallel data is output to the sync detector 123B. The latter attains synchronization by detecting a break in the code of the 10-bit units from the pattern of the input parallel data and outputs 10-bit code to the align detector 125B. The latter adjusts the skew between the lanes of the data that is sent in on the transmission paths of the four lanes. The 10-bit code that has been adjusted for skew between lanes enters the 8B/10B decoder 127B. The latter converts the 10-bit code to the original 8-bit data and outputs this data to the control circuit B.

Similarly, communication from control circuit B to control circuit A is performed via the transmitter 110B of communication circuit 101B and the receiver 120A of communication circuit 101A. The characters “A” and “B” that have been appended to reference numerals indicated above are merely changed to “B” and “A”, respectively, and therefore a detailed description of communication from control circuit B to control circuit A is omitted.

The flow of the data sequence is such that the data-column sequence and idle-column sequence are in line, as illustrated in FIG. 2. In the case of an XAUI interface of a 10 Gigabit Ethernet (registered trademark), the interface has a serial transmission path of 3.125 Gbps of four lanes. One of these lanes is illustrated in FIG. 2. Control circuits (each of the devices) are connected by this serial 4-lane interface. Data columns (data of MAC frames) or idle columns (which correspond to the IFG that flows between MAC frames) flow constantly on the XAUI transmission path. Link establishment and monitoring are implemented using the idle columns. Idle columns are of three types, namely a sync column (K), an align column (A) and a skip column (R). Sync columns are used to establish synchronization, and align columns are used to establish alignment. Synchronization (detection of a break in the data of the 10-bit units from the serial bit stream) and alignment (skew adjustment between lanes) are monitored at all times at the receive end of the interface. When both synchronization and alignment have been established, this signifies link establishment. When a link is established, the streams of the idle columns are in line from lane 0 to lane 3, as shown in FIG. 3. A skew adjustment is made in such a manner that the align columns (A) will appear simultaneously.

Thus, with the conventional implementation, the status of link establishment of one's own station is merely monitored and communication can be activated when the link has been established; there is no mechanism for notifying the other station of the status of link establishment of one's own station. Accordingly, whether the opposite station has achieved link establishment cannot be monitored and detection of failure of the XAUI interface cannot be carried out. That is, maintenance and monitoring cannot be performed in the XAUI layer. This means that a redundant arrangement such as by duplexing cannot be adopted.

The specification of Japanese Patent Kokai Publication No. JP-P2002-158686A discloses art relating to an asymmetric data path media access controller. This is a method of maintaining throughput in a data element. The method of maintaining throughput in a data element includes a receiving step, a processing step and a transmitting step. The receiving step receives a clock and a plurality of instances of data having a first width on an input. The processing step is a step of processing consecutive ones of the plurality of instances of data having the first width to produce two or more of a plurality of instances having a second data width. The second data width is equivalent to the first data width. The two or more of the plurality of instances of data having the second data width are used to produce a plurality of instances of data having a third data width. The third data width is greater than the second data width. The plurality of instances of data having the third data width are used to produce a plurality of instances of data having an output data width. The output data width is equivalent to the third data width. The transmitting step transmits a plurality of instances of data having the output data width.

More specifically, the method and apparatus for maintaining data throughput of a data element include receiving a clock and a first plurality of instances of data of a first width, and sampling consecutive ones of the instances of the data of the first width at consecutive ones of a first rising edge and falling edge of the clock in order to produce two pluralities of instances of sampled data of the first width. The plurality of instances of sampled data are sampled at a second rising edge of the clock and are parallelized in order to produce a second plurality of instances of parallel data having the second width greater than the first width. In order to monitor the integrity of a link before the parallel data is transmitted, statistical information, for example, can be produced. A data transmission rate of 10 Gbps can be maintained using a medium-independent interface clock specified in IEEE 802.3ae.

Further, the specification of Japanese Patent Kokai Publication No. JP-P2003-134074A discloses art relating to a transmission system in which a SONET/SDH network having a high-speed LAN optical IF is connected to an IP network. This is a technique in each transmitting device that constructs a transmission system in which packetized transmit signals are sent and received. Each transmitting device comprises a redundant transmission line, a generator, a transmitter and a redundant changeover unit. The redundant transmission line comprises a plurality of transmission paths. The generator generates specific byte data representing transmission-changeover control information regarding the transmission path, packetizes the signal and outputs the packet. The transmitter transmits the packet, which has been output from the generator, to the opposite transmitter provided at the opposite end via the transmission path. In accordance with the state of reception of the packetized specific byte data from the opposite transmitter, the redundant changeover unit is capable of selectively changing over the transmission path on which is transmitted a transmission signal that contains informational data.

The specification of Japanese Patent Kokai Publication No. JP-P2002-271287A describes art relating to a multiplexed transmission system in which n channels (where n is an integer of 2 or greater) of input data sequences are transmitted from a transmit node to a receive node. The transmitting system of this multiplexed transmission system includes time division multiplexing means, transmit interface converting means and a packet transmitting unit. The time division multiplexing means time-division multiplexes n channels of input data sequences and outputs the data to a multiplexed output unit as a multiplexed output data sequence. The transmit interface converting means partitions the multiplexed output data sequence successively into blocks having a prescribed block length and appends prescribed packet information to the blocks to construct a packet. The transmit interface converting means outputs the packet to the interface of the packet transmitting unit as a packet transmitting unit interface data sequence. The packet transmitting unit transmits the packet transmitting unit interface data sequence.

A demultiplexing receiving system of the multiplexed transmission system includes a packet receiving unit, receive interface converting means and demultiplexing means. The packet receiving unit receives a transmit packet data sequence and outputs a packet receiving unit interface data sequence to a packet receive interface. The receive interface converting means extracts packets from the packet receiving unit interface data sequence, couples the blocks contained in the packets successively obtained and generates a demultiplexed input data sequence. The demultiplexing means time-division demultiplexes the demultiplexed input data sequence into desired channels.

[Patent Document 1]

Japanese Patent Kokai Publication No. JP-P2002-158686A

[Patent Document 2]

Japanese Patent Kokai Publication No. JP-P2003-134074A

[Patent Document 3]

Japanese Patent Kokai Publication No. JP-P2002-271287A

### SUMMARY OF THE DISCLOSURE

A communication circuit in accordance with a first aspect of the present invention, which is connected to an opposite communication circuit via a plurality of serial data transmission paths and which includes a link establishment detector, an idle generator and a link monitoring unit. The link establishment detector detects link status, which indicates whether reception is possible from receive data that enters from the plurality of serial data transmission paths, and outputs link establishment information. The idle generator generates transmit data, which indicates the link status, based upon the link establishment information and transmits the transmit data to the plurality of serial data transmission paths. The link monitoring unit extracts the link establishment information, which is sent by the opposite communication circuit, from the receive data that enters from the plurality of serial data transmission paths. The communication circuit sends and receives the link establishment information to and from the opposite communication circuit, whereby the communication circuits monitor each other's link status.

The receive data and the transmit data in the present invention include a data column sent and received while holding communication information, and an idle column sent and received in order to control communication. The idle generator assigns the link establishment information to the idle column.

The idle columns in the present invention include an align column, a sync column and a skip column. The align column is sent and received periodically and is used to adjust skew between transmission paths. The sync column is used to establish synchronization of the receive data. When the link establishment information indicates non-establishment of the link, the idle generator assigns the align column, which indicates non-establishment of the link, to an idle column that follows the align column sent and received periodically. Accordingly, align columns are transmitted consecutively in case of non-establishment of a link and are not consecutive in case of link establishment.

The idle generator in the present invention sends the align column that indicates link non-establishment to at least one serial data transmission path among the plurality of serial data transmission paths.

In a case where the align column is received consecutively a plurality of times, the link monitoring unit of the present invention judges that the opposite communication circuit (201B, 201A) is transmitting link non-establishment and ignores the align column received subsequently.

The idle columns in the present invention include an align column, a sync column and a skip column. The align column is sent and received periodically and is used to adjust skew between transmission paths. The sync column is used to establish synchronization of the receive data. The idle generator sets the link establishment information in a signal column assigned instead of an idle column that is other than the align column.

The idle generator in the present invention assigns the signal column at prescribed intervals so as to be output periodically.

The signal column in the present invention has a parameter section. The idle generator sets data, which indicates the link establishment information, in the parameter section.

The link monitoring unit in the present invention extracts the link establishment information from the signal column received.

The interface of the plurality of serial data transmission paths in the present invention is an XAUI (10 Gigabit Attachment Unit Interface).

An apparatus according to the present invention is equipped with the communication circuit described above.

According to another aspect of the present invention, there is provided a communication method for a communication circuit communicating with an opposite communication circuit via a plurality of serial data transmission paths. The communication method includes a link establishment detecting step, an idle generating step and a link monitoring step. The link establishment detecting step detects a link state, which indicates whether receive data that enters from the plurality of serial data transmission paths is capable of being received, and outputs link establishment information. The idle generating step generates transmit data, which indicates the link state, based upon the link establishment information and transmits the transmit data to the plurality of serial data transmission paths. The link monitoring step extracts the link establishment information, which is sent by the opposite communication circuit, from the receive data that enters from the plurality of serial data transmission paths. In the communication method according to the present invention, the communication circuit sends and receives the link establishment information to and from the opposite communication circuit, whereby the communication circuits monitor each other's link status.

The receive data and the transmit data in the present invention include a data column sent and received while holding communication information, and an idle column sent and received in order to control communication. The idle generating step assigns the link establishment information to the idle column.

The idle columns in the present invention include an align column, a sync column and a skip column. The align column is sent and received periodically and is used to adjust skew between transmission paths. The sync column is used to establish synchronization of the receive data. When the link establishment information indicates non-establishment of the link, the idle generating step assigns the align column, which indicates non-establishment of the link, to an idle column that follows the align column sent and received periodically. Accordingly, align columns are transmitted consecutively in case of non-establishment of a link and are not consecutive in case of link establishment.

The idle generating step sends the align column that indicates link non-establishment to at least one serial data transmission path among the plurality of serial data transmission paths.

In a case where the align column is received consecutively a plurality of times, the link monitoring step of the present invention judges that the opposite communication circuit is transmitting link non-establishment and ignores the align column received subsequently.

The idle columns in the present invention include an align column, a sync column and a skip column. The align column is sent and received periodically and is used to adjust skew between transmission paths. The sync column is used to establish synchronization of the receive data. The idle generator sets the link establishment information in a signal column assigned instead of an idle column that is other than the align column.

The idle generating step in the present invention assigns the signal column at prescribed intervals so as to be output periodically.

The signal column in the present invention has a parameter section. The idle generating step sets data, which indicates the link establishment information, in the parameter section.

The link monitoring step in the present invention extracts the link establishment information from the signal column received.

The interface of the plurality of serial data transmission paths in the present invention is an XAUI (10 Gigabit Attachment Unit Interface).

The apparatus according to the present invention communicates using the above-described communication method.

The meritorious effects of the present invention are summarized as follows. In accordance with the present invention, there are provided a communication circuit and method capable of monitoring and maintaining an interface transmission path.

In accordance with the present invention, there are also provided a communication circuit and method capable of furnishing a duplexing mechanism for an interface transmission path.

Furthermore, in accordance with the present invention, there can be provided a communication circuit and method for performing a data transmission that conforms to the status of the opposite station.

Other features and advantages of the present invention will be apparent from the following description taken in conjunction with the accompanying drawings, in which like reference characters designate the same or similar parts throughout the figures thereof.

Still other objects and advantages of the present invention will become readily apparent to those skilled in this art from the following detailed description in conjunction with the accompanying drawings wherein only the preferred embodiments of the invention are shown and described, simply by way of illustration of the best mode contemplated of carrying out this invention. As will be realized, the invention is capable of other and different embodiments, and its several details are capable of modifications in various obvious respects, all without departing from the invention. Accordingly, the drawing and description are to be regarded as illustrative in nature, and not as restrictive.

### BRIEF DESCRIPTION OF THE DRAWINGS

FIG. 1 is a block diagram illustrating the structure of a communication circuit according to the prior art;

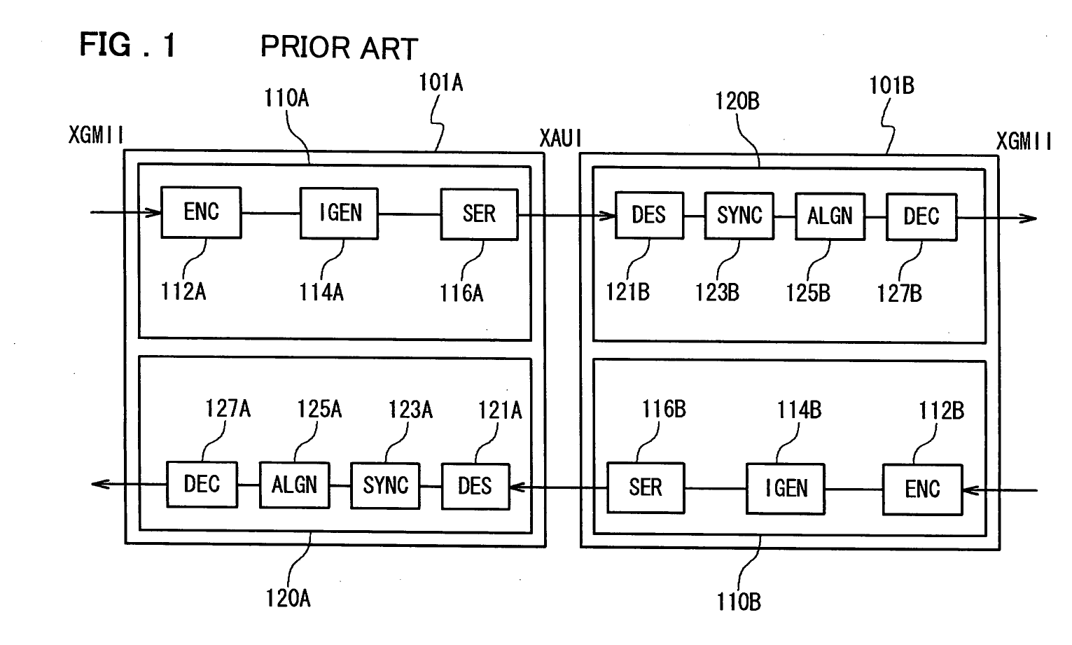

FIG. 2 is a diagram illustrating data that flows on a transmission path according to the prior art (one lane only);

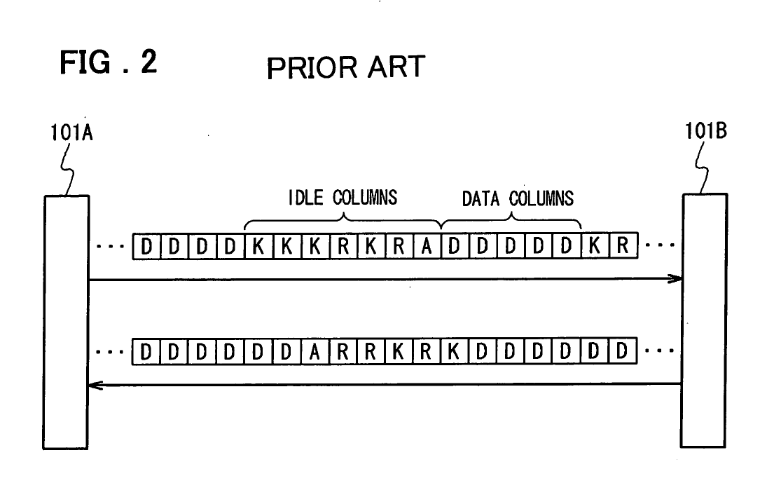

FIG. 3 is a diagram illustrating the status of idle columns in link establishment according to the prior art;

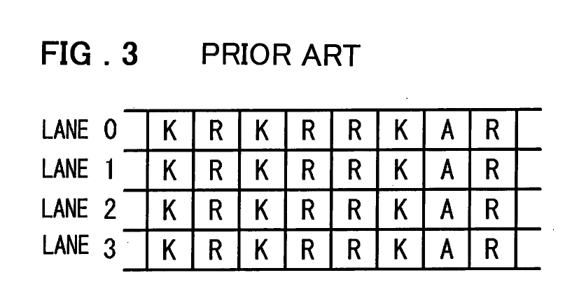

FIG. 4 is a block diagram illustrating the configuration of a communication circuit according to a first embodiment of the present invention;

FIG. 5 is a diagram illustrating data that flows on a transmission path according to the first embodiment (one lane only);

FIGS. 6a and 6b are diagrams illustrating the status of idle columns in link establishment according to the first embodiment;

FIG. 7 is a diagram illustrating operation according to the first embodiment;

FIG. 8 is a diagram illustrating data that flows on a transmission path according to a second embodiment of the present invention;

FIGS. 9a and 9b are diagrams illustrating the status of idle columns according to the second embodiment; and

FIG. 10 is a diagram illustrating operation according to the second embodiment.

### PREFERRED EMBODIMENTS OF THE INVENTION

Preferred embodiments of the present invention will now be described in detail with reference to the drawings.

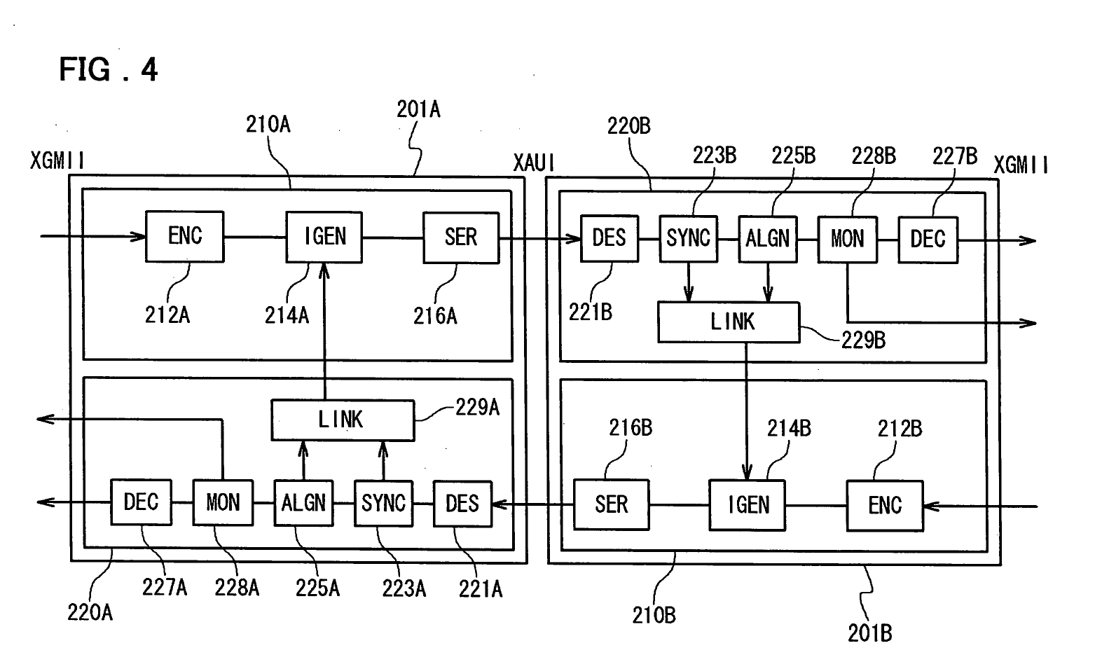

FIG. 4 illustrates the configuration of a system in which communication circuits 201A and 201B communicate with each other by an XAUI interface. The communication circuit 201A is connected by a control circuit A (not shown) and an XGMII (10 Gigabit Media Independent Interface). The communication circuit 201B is connected by another control circuit B (not shown) and an XGMII. The communication circuits 201A and 201B intervene in the information sent and received between the control circuits A and B. Data in units referred to as columns constantly flow between the communication circuits 201A and 201B. Columns include data columns that handle the data of MAC frames and idle columns that flow into an IFG (Inter-Frame Gap) between MAC frames.

The communication circuit 201A has a transmitter 210A and a receiver 220A. The transmitter 210A has an 8B/10B encoder 212A, an idle generator 214A and a serializer 216A. The receiver 220A has a deserializer 221A, a sync detector 223A, an align detector 225A and an 8B/10B decoder 227A. The communication circuit 201B constituting the opposite station similarly has a transmitter 210B and a receiver 220B. The transmitter 210B has an 8B/10B encoder 212B, an idle generator 214B and a serializer 216B. The receiver 220B has a deserializer 221B, a sync detector 223B, an align detector 225B and an 8B/10B decoder 227B.

Data transmitted to the control circuit B enters the transmitter 210A of the communication circuit 201A from the control circuit A. Parallel data that enters the transmitter 210A is input to the 8B/10B encoder 212A, and 8-bit parallel data is converted to 10-bit code. The data that has been converted to the 10-bit code is input to the idle generator 214A. When data enters from the 8B/10B encoder 212A, the idle generator 214A outputs this data. When data does not enter from the 8B/10B encoder 212A, i.e., in the IFG, the idle generator 214A generates and outputs an idle column. At this time the idle generator 214A appends information, which indicates that a link has been established, to the idle column based upon link establishment information that enters from a link detector 229A. The appending of this information will be described separately. A data column and idle column that are output from the idle generator 214A are input to the serializer 216A. The latter converts 10-bit parallel data to serial data and outputs the serial data.

Only one lane is shown in FIG. 4 in order to simplify the description. This serial transmission path, however, has four lanes. The parallel data in each lane is similarly converted to serial data and transmitted to the communication circuit 201B. The appending of the link establishment information is not limited to one lane and may just as well be performed for all lanes. In a case where information is appended with regard to a plurality of lanes, redundancy increases and reliability is enhanced.

The output serial data is input to the receiver 201B of the opposite communication circuit 201B. The serial data that enters is converted to parallel data by the deserializer 221B and the parallel data is output to the sync detector 223B. The latter attains synchronization by detecting a break in the code of the 10-bit units from the pattern of the input parallel data and outputs 10-bit code to the align detector 225B. The latter adjusts the skew between the lanes of the data that is sent in on the transmission paths of the four lanes. The 10-bit code that has been adjusted for skew between lanes enters a link monitoring unit 228B. The latter monitors link establishment information that is sent in from the communication circuit 201A. More specifically, the link monitoring unit 228B performs monitoring to determine whether the communication circuit 201A is in a state of link establishment and notifies the control circuit B as to whether data transmitted by the communication circuit 201B will be received.

The link monitoring unit 228B outputs the data to the 8B/10B decoder 227B after it has monitored the link establishment information. In a case where manipulation of data is not carried out, as when the link monitoring unit 228B discards data prevailing prior to link establishment, data may just as well be input directly from the align detector 225B to the 8B/10B decoder 227B. The latter converts the 10-bit code to the original 8-bit data and outputs this data to the control circuit B.

The status of synchronization from the sync detector 223B and the status of alignment from the align detector 225B enter a link detector 229B, which proceeds to detect link establishment based upon the sync state and align state. That is, if synchronization is detected by the sync detector 223B and alignment is detected by the align detector 225B, the link detector 229B judges that a link has been established. The link detector 229B outputs the detected link establishment information to the idle generator 214B. The link establishment information is information indicating whether link establishment has been achieved with regard to the signal that the communication circuit 201A has sent to the communication circuit 201B.

Similarly, communication from control circuit B to control circuit A is performed via the transmitter 210B of communication circuit 201B and the receiver 220A of communication circuit 201A. The characters “A” and “B” that have been appended to reference numerals indicated above are merely changed to “B” and “A”, respectively, and therefore a detailed description of communication from control circuit B to control circuit A is omitted.

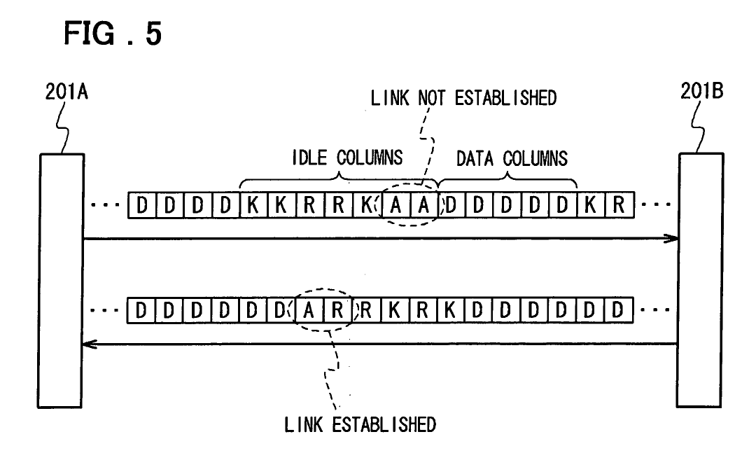

The flow of the data sequence is such that the data-column sequence and idle-column sequence are in line, as illustrated in FIG. 5. In the case of an XAUI interface of a 10 Gigabit Ethernet (registered trademark), the interface has a serial transmission path of 3.125 Gbps of four lanes. One of these lanes is illustrated in FIG. 5. Control circuits (each of the devices) are connected by this serial 4-lane interface. Data columns (data of MAC frames) or idle columns (which correspond to the IFG that flows between MAC frames) flow constantly on the XAUI transmission path.

Link establishment and monitoring are implemented using the idle columns. Idle columns are of three types, namely a sync column (K), an align column (A) and a skip column (R). Sync columns are used to establish synchronization, and align columns are used to establish alignment. With the conventional XAUI interface, the align columns (A) are sent periodically at intervals of 17 to 32 columns. Accordingly, the align columns are not consecutive. Portions in the idle columns other than the periodically generated align columns (A) are filled with the sync columns (K) and skip columns (R), which are produced randomly.

By changing the transmission pattern of the align columns being sent periodically, this is used as link establishment information. In a case where align columns are generated consecutively, this indicates link non-establishment. In a case where the align columns (A) are generated periodically and not consecutively as heretofore, this indicates link establishment.

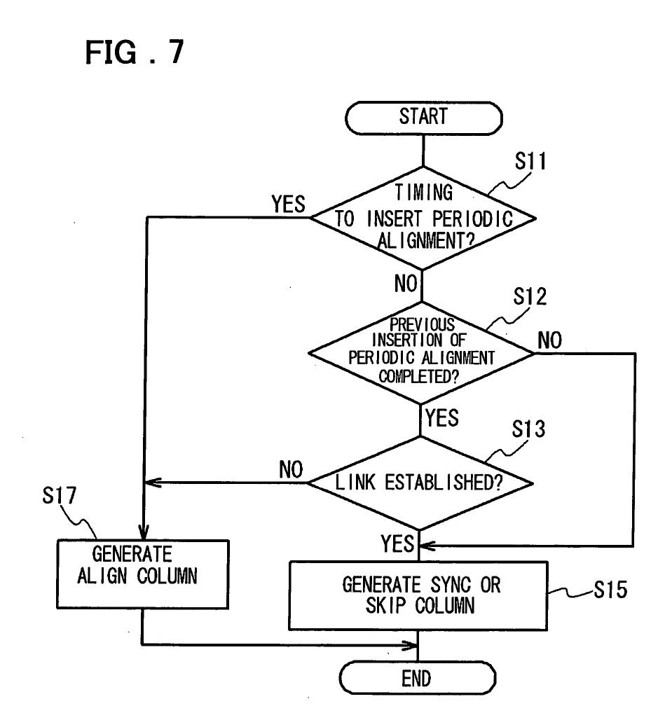

The idle generators 214A and 214B generate align columns (A) based upon link information that enters from the link detectors 229A and 229B, as illustrated in FIG. 7.

When the idle generators 214A and 214B start to generate idle columns, they determine whether this is the periodic timing for generating an align column (A) that adjusts data skew on a per-lane basis (step S11). If this is the timing for inserting the periodic alignment (“YES” at step S11), then the align column (A) is generated (step S17). Here an align column that is generated periodically shall be referred to as a “periodic align column”. If this is not the timing for inserting a periodic align column, (“NO” at step S1), then it is determined whether the idle column generated previously is a periodic align column, i.e., whether this is the timing for appending link establishment information (step S12). If the previously generated idle column is not a periodic align column (“NO” at step S12), then this is not the timing for appending link establishment information and therefore the sync columns (K) and skip columns (R) are generated randomly (step S15).

If the previously generated idle column is a periodic align column (“YES” at step S12), then this is the timing for appending link establishment information and therefore it is determined whether the link establishment state has been achieved based upon link information that enters from the link detectors 229A and 229B (step S13). If the receivers 220A, 220B have not achieved the state of link establishment (“NO” at step S13), this indicates link non-establishment and, hence, the align column (A) is generated (step S17). That is, the align column (A), which indicates link non-establishment, is generated following the periodic align column (A).

If the state is that of link establishment (“YES” at step S13), then this indicates link establishment and hence the sync columns (K) and skip columns (R) are generated randomly (step S15). This is repeated whenever an idle column is generated. Information indicative of the state of link establishment thus is appended to the idle column.

The data sequence that has been generated by the above operation is such that idle columns are packed between the streams of data columns (D), as illustrated in FIG. 5. Align columns (A) appear consecutively in the idle columns sent from the communication circuit 201A to the communication circuit 201B, and the communication circuit 201A indicates that a link has not been established. There are no consecutive align columns (A) in the idle columns sent from the communication circuit 201B and the communication circuit 201B indicates that a link has been established.

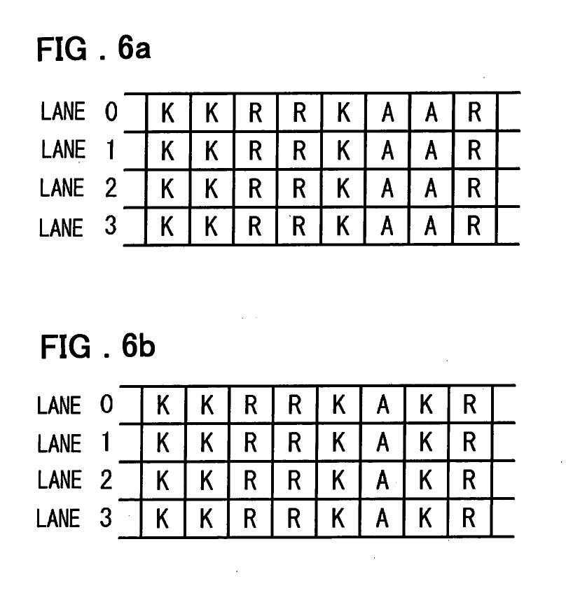

Using the respective link monitoring units 228A and 228B of the receivers 220A and 220B, the communication circuits 201A and 201B monitor the status of link establishment of the opposite stations based upon the receive pattern of align columns (A) thus generated. FIGS. 6a and 6b illustrate examples of the idle columns received. In FIGS. 6a and 6b illustrate examples of idle columns in the state of link non-establishment and the state of link establishment, respectively. Thus, the patterns of the idle columns transmitted on the four lanes are discriminated in the link monitoring units 228A and 228B.

In a case where align columns (A) arrive consecutively, as illustrated in FIG. 6a, the opposite station has not attained the state of link establishment. Accordingly, the align detectors 225A and 225B perform a skew adjustment of the data based upon the first align column (A) and ignore the second align column (A) without using it in detection of alignment. In other words, only the first align column is applied to alignment detection, which is the original method of use, and the second align column is used only as link establishment information. Here the second align column may just as well be used in alignment detection without being ignored.

In a case where align columns (A) arrive non-consecutively, as illustrated in FIG. 6b, the opposite station has attained the state of link establishment. Accordingly, the align detectors 225A and 225B perform a skew adjustment of the data based upon the align column (A) and detect alignment just as in the prior art.

In FIG. 6a, the align columns (A) at the time of link establishment are placed in all lanes. However, such an alignment column may be placed only in any one of the lanes. In such case align columns for alignment detection would be placed in all lanes and alignment columns for link establishment information would be placed in at least one lane, thereby making distinction possible.

As indicated above, information indicating the state of link establishment detected at one's own station can be transmitted to the opposite station using the align column among the idle columns. Further, it is possible to monitor the link establishment status that indicates whether a link has been established at the opposite station from idle columns sent in from the opposite station, i.e., whether data being sent by one's own station is being received at the opposite station.

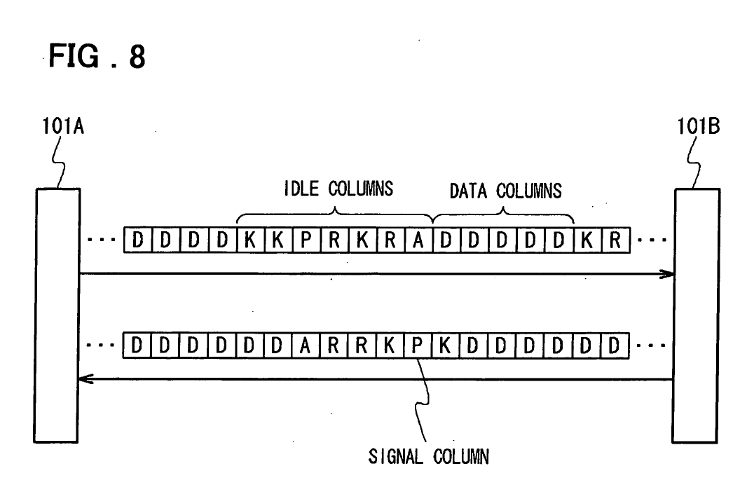

Another method of sending link establishment information to an opposite station using idle columns will now be described. Use is made of a signal column (P) to send and receive link establishment information. Monitoring of the link establishment information of the opposite station is made possible by sending and receiving link establishment or link non-establishment information upon placing the information in the signal column. As illustrated in FIG. 8, transmission of the signal column (P) is by replacing part of the idle columns with signal column (P). With an XAUI interface, a signal column is a reserved column and therefore no problem arises by using a signal column in a state in which it is confined within the XAUI interface.

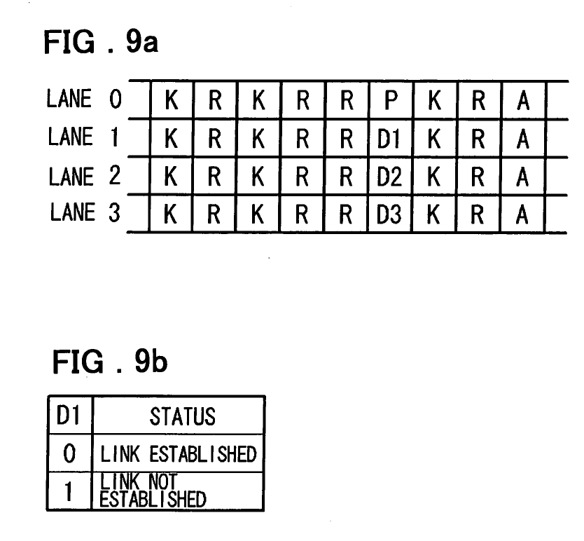

The idle columns are such that sync, align and skip columns place identical codes on all four lanes, as described thus far. The signal column (P) is such that a code indicative of the signal column is placed only on lane 0 while any data is placed on the other lanes 1, 2 and 3. That is, the signal column (P) is placed on lane 0 and any data (D1, D2, D3) is placed on lanes 1 to 3, as indicated at FIG. 9a. Link establishment information is placed in these data portions. For example, any data D1 placed on lane 1 is such that “0” is made to correspond to link establishment and “1” is made to correspond to link non-establishment, as indicated at FIG. 9b.

If assignments are made in this manner, the idle generators 214A and 214B generate signal column (P) and the data D1 indicating the status of link establishment. The idle generators 214A, 214B generate and transmit the sync column (K), align column (A) and skip column (R) when there is no data column sent to the opposite station. The align column (A) among these is generated periodically. The signal column (P) is generated periodically in the same manner as the align column (A). The sync column (K), align column (A) and skip column (R) are generated randomly and assigned to the other portions. That is, in contrast with the generation of the idle column in the prior art, the sync column or skip column is periodically replaced by the signal column. Link establishment information is placed in the data of any data D1 based upon the link establishment information delivered from the link detectors 229A and 229B when the signal column is generated periodically.

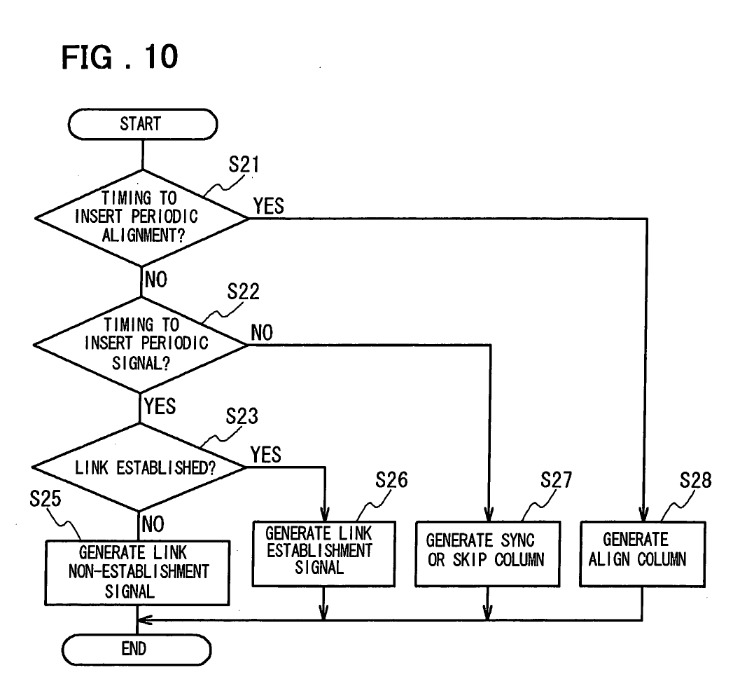

The operation of the idle generators 214A and 214B will be described with reference to FIG. 10.

When an idle column is generated, first it is determined whether this is the timing for inserting periodic alignment (step S21). The periodic alignment is sent periodically at intervals of 17 to 32 columns. If it is determined that this is the timing for insertion (“YES” at step S21), then align column (A) is generated (step S28).

If this is not the timing for periodic alignment (“NO” at step S21), then it is determined whether this is the timing for insertion of the signal column (P) (step S22). If this is the timing for inserting the signal column (P), then this is an interval in which the status of link establishment is monitored and it is preferred that an external setting be possible. If this is not the timing for inserting a signal column (“NO” at step S22), then the sync columns (K) and skip columns (R) are generated randomly (step S27).

If this is the timing for generating the signal column (P) (“YES” at step S22), then the status of link establishment is checked based upon the link establishment information that enters from the link detectors 229A, 229B (step S23). If the link has been established (“YES” at step S23), then the link establishment signal column (P) in which the data D1 has been made “0” is generated (step S26). If the link has not been established (“NO” at step S23), then the link non-establishment signal column (P) in which the data D1 has been made “1” is generated (step S25).

The idle columns thus generated, which include the signal column (P) and the align column (A) that are generated periodically, are transmitted to the opposite station. The receivers 220A, 220B of the communication circuits 210A, 210B receive the idle columns that include the signal column (P), synchronization and establishment of alignment of one's own station are monitored by the sync detectors 223A, 223B and align detectors 225A, 225B, and the state of link establishment of the opposite station is monitored by the link monitoring units 228A, 228B.

If the link monitoring units 228A, 228B detect the code portion of the signal column (P), then the content of the data portion D1 is checked. That is, if the data D1 is “0”, then it is judged that the opposite station is in the state of link establishment. If the data D1 is “1”, then it is judged that the opposite station is in the state of link non-establishment. The result of detection is sent to the controller.

The method of transmission and detection of link establishment information will now be described. A communication system configured for redundancy will be described as an example of application in which operation is based upon the transmitted link establishment information. In the case of a redundant arrangement in which a transmission path of the kind shown in FIG. 4 is provided in two channels, let one channel be a 0 channel and the other a 1 channel. Communication normally is performed by the 0 channel. If the communication circuit 201A of the 0 channel detects link non-establishment by the link monitoring unit 228A, then it is predicted that a failure has occurred on the transmission path on which the transmitter 210A of the communication circuit 201A of the 0 channel transmits. Accordingly, the controller A switches from the 0 channel to the communication circuit 201A of the 1 channel. In the case of the communication circuit 201B on the 0 channel of the opposite station, link non-establishment is being transmitted and therefore the controller B monitors the reception state of the communication circuit 201B of the 1 channel switches the communication circuit 201B from the 0 channel to the 1 channel at the moment link establishment is attained. Thus, switching of a redundant arrangement becomes possible by the link establishment information.

Thus, synchronization and detection of alignment for the purpose of link establishment are implemented in the same manner as in the prior art. However, the receiver has a mechanism for notifying the transmitter of link establishment information at the receiver by way of detecting synchronization and alignment. The transmitter periodically generates and transmits a column in which link information has been placed in an idle column generating unit based upon the link establishment information. Accordingly, link establishment information at the receive end of one's own station can be sent periodically to the opposite station, and link establishment information at the receive end of the opposite station is sent to one's own station. Furthermore, the receiver has a mechanism for monitoring link establishment information of the opposite station and monitors the status of link establishment of the opposite station. By adopting this arrangement, maintenance and monitoring of an XAUI transmission path can be performed. In addition, it is possible to furnish a duplexed mechanism for an XAUI transmission path. Furthermore, data transfer conforming to the conditions of the opposite station can be carried out. For example, data is not transferred when a link has not been established at the opposite station.

As many apparently widely different embodiments of the present invention can be made without departing from the spirit and scope thereof, it is to be understood that the invention is not limited to the specific embodiments thereof except as defined in the appended claims.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

1. A communication circuit connected to an opposite communication circuit via a plurality of serial data transmission paths, comprising:
a link establishment detector for detecting link status, which indicates whether reception is possible from receive data input from the plurality of serial data transmission paths, and outputting link establishment information;
an idle generator for generating transmit data, which indicates the link status, based upon the link establishment information and transmitting the transmit data to the plurality of serial data transmission paths; and
a link monitoring unit for extracting the link establishment information, sent by the opposite communication circuit, from the receive data;
wherein said communication circuit sends and receives link establishment information to and from said opposite communication circuit, the communication circuits monitoring each other's link status.

2. The communication circuit according to claim 1, wherein the receive data and the transmit data include:
a data column sent and received while holding communication information; and
an idle column sent and received in order to control communication;
said idle generator assigning the link establishment information to the idle column.

3. The communication circuit according to claim 2, wherein the idle columns include:
an align column, sent and received periodically and used to adjust skew between transmission paths;
a sync column used to establish synchronization of the receive data; and
a skip column;
said idle generator assigning the align column, which indicates non-establishment of the link, to an idle column that follows said align column sent and received periodically.

4. The communication circuit according to claim 3, wherein said idle generator sends the align column that indicates link non-establishment to at least one serial data transmission path among the plurality of serial data transmission paths.

5. The communication circuit according to claim 3, wherein in a case where the align column is received consecutively a plurality of times, said link monitoring unit judges that the opposite communication circuit is transmitting link non-establishment and ignores the align column received subsequently.

6. The communication circuit according to claim 2, wherein the idle columns include:
an align column sent and received periodically and used to adjust skew between transmission paths;
a sync column used to establish synchronization of the receive data; and
a skip column;
said idle generator setting the link establishment information in a signal column assigned instead of an idle column that is other than the align column.

7. The communication circuit according to claim 6, wherein said idle generator assigns the signal column at prescribed intervals.

8. The communication circuit according to claim 6, wherein the signal column has a parameter section;
said idle generator setting data, which indicates the link establishment information, in the parameter section.

9. The communication circuit according to claim 6, wherein said link monitoring unit extracts the link establishment information from the signal column received.

10. The communication circuit according to claim 1, wherein the interface of the plurality of serial data transmission paths is an XAUI (10 Gigabit Attachment Unit Interface).

11. An apparatus equipped with the communication circuit set forth in claim 1.

12. A communication method for a communication circuit communicating with an opposite communication circuit via a plurality of serial data transmission paths, comprising:
a link establishment detecting step of detecting link status, which indicates whether reception is possible from receive data input from the plurality of serial data transmission paths, and outputting link establishment information;
an idle generating step of generating transmit data, which indicates the link status, based upon the link establishment information and transmitting the transmit data to the plurality of serial data transmission paths; and
a link monitoring step of extracting the link establishment information, which is sent by the opposite communication circuit, from the receive data;
wherein the communication circuit sends and receives link establishment information to and from said opposite communication circuit, the communication circuits monitoring each other's link status.

13. The method according to claim 12, wherein the receive data and the transmit data include:
a data column sent and received while holding communication information; and
an idle column sent and received in order to control communication;
said idle generating step assigning the link establishment information to the idle column.

14. The method according to claim 13, wherein the idle columns include an align column, which is sent and received periodically and used to adjust skew between transmission paths, a sync column used to establish synchronization of the receive data, and a skip column;
said idle generating step assigning the align column, which indicates non-establishment of the link, to an idle column that follows said align column sent and received periodically.

15. The method according to claim 14, wherein the idle generating step sends the align column that indicates link non-establishment to at least one serial data transmission path among the plurality of serial data transmission paths.

16. The method according to claim 14, wherein in a case where the align column is received consecutively a plurality of times, said link monitoring step judges that the opposite communication circuit is transmitting link non-establishment and ignores the align column received subsequently.

17. The method according to claim 13, wherein the idle columns include:
an align column sent and received periodically and used to adjust skew between transmission paths;
a sync column used to establish synchronization of the receive data; and
a skip column;
said idle generating step setting the link establishment information in a signal column assigned instead of an idle column that is other than the align column.

18. The method according to claim 17, wherein said idle generating step assigns the signal column at prescribed intervals.

19. The method according to claim 17, wherein the signal column has a parameter section;
said idle generating step setting data, which indicates the link establishment information, in the parameter section.

20. The method according to claim 17, wherein said link monitoring step extracts the link establishment information from the signal column received.

21. The method according to claim 12, wherein the interface of the plurality of serial data transmission paths is an XAUI (10 Gigabit Attachment Unit Interface).

22. An apparatus for communicating using the communication method set forth in claim 12.
